(19) United States
(12) Patent Application Publication
(10) Pub. No.: US 2014/0103828 A1
(43) Pub. Date: Apr. 17, 2014

(54) METHODS AND CIRCUITS FOR SUPPLYING A PULSED CURRENT TO LEDS

(71) Applicant: Wen-Hsiung Hsieh, Keelung (TW)

(72) Inventor: Wen-Hsiung Hsieh, Keelung (TW)

(21) Appl. No.: 13/651,484

(22) Filed: Oct. 15, 2012

(51) Int. Cl. H05B 37/02

(52) U.S. Cl. 315/201; 315/210

(57) ABSTRACT

Methods and circuits for driving one or more than one light-emitting diodes with a pulsed current are disclosed.

Each of said circuits comprises: an inductance means; a switching unit for switching a current flowing through a loop comprising a direct current voltage, said light-emitting diodes and the inductance means and for either switching a current flowing from the inductance means to the direct current voltage or switching a current flowing from the direct current voltage to the inductance means; a switching control unit for controlling said switching to regulate the current of the inductance means for supplying the pulsed current to said light-emitting diodes.

Accordingly, the present invention provides a switching-mode pulsed current supply circuit for driving white light-emitting diodes that is able to provide higher perceived brightness levels and has much longer lifetime than existing light-emitting diode drivers.

### TECHNICAL FIELD

The technical field of this disclosure is switching mode pulsed current regulator circuits, particularly, a pulsed current regulator circuit for driving one or more than one light-emitting diodes with a pulsed current.

### BACKGROUND OF THE INVENTION

Significant advances have been made in the technology of white light-emitting diodes. White light-emitting diodes are commercially available which generate 60˜100 lumens/watt. This is comparable to the performance of fluorescent lamps; therefore there have been a lot of applications in the field of lighting using white light-emitting diodes.

Various light-emitting diode driver circuits are known from the prior arts. For example, U.S. Pat. No. 6,304,464: “FLYBACK AS LED DRIVER”; U.S. Pat. No. 6,577,512: “POWER SUPPLY FOR LEDS”; and U.S. Pat. No. 6,747,420: “DRIVER CIRCUIT FOR LIGHT-EMITTING DIODES”. All the light-emitting diode driver circuits mentioned above are constant current regulator circuits that act as constant current sources to drive light-emitting diodes.

In the field of lighting applications, for a white light-emitting diode lamp driven by a constant current source and a fluorescent lamp driven by an alternating current source under the condition that both lamps' remitted illumination have the same average illumination value, the fluorescent lamp provides higher perceived brightness levels than the white light-emitting diode lamp, the main reason is: human eyes are responsive to the peak value of illumination; therefore, if a lamp can provide higher peak illumination, it provides higher perceived brightness levels. For a fluorescent lamp driven by an alternating current (AC) source, it remits illumination with peak value higher than its average illumination value. But for a white light-emitting diode lamp driven by a constant current source, since light generation of a white light-emitting diode is dependent on the current strength through the white light-emitting diode, it remits illumination with peak value close to its average illumination value. Therefore, a white light-emitting diode lamp driven by a constant current regulator circuit constitutes a drawback of its remitted illumination with low perceived brightness levels.

In addition, for a constant current regulator circuit, including boost, buck-boost, non-isolated flyback or isolated flyback converter topologies etc., a large enough capacitance is needed in its output filter circuit to supply a constant current continuously during the period when its semiconductor switching element is closed. Thus generally at least one aluminum electrolytic capacitor is used to fulfill the requirement of a large enough capacitance. However, since lifetime of a white light-emitting diode is usually more than 20,000 average life hours, but lifetime of an aluminum electrolytic capacitor is usually from 1,000 to 5,000 average life hours only. Thus this constitutes a drawback of limited lifetime in the field of lighting applications due to the usage of aluminum electrolytic capacitors.

It would be desirable to have a light-emitting diode driving circuit that would overcome the above disadvantages.

### SUMMARY OF THE INVENTION

One aspect of the present invention provides a method of driving one or more than one light-emitting diodes with a pulsed current comprising the steps of: charging an inductance means via switching on a current flowing through a loop comprising said light-emitting diodes, the inductance means and the direct current (DC) voltage; discharging the inductance means via switching on a current flowing from the inductance means to the direct current (DC) voltage for transferring energy stored in the inductance means to the direct current (DC) voltage; controlling said charging and discharging to regulate the current of the inductance means for supplying the pulsed current to said light-emitting diodes.

Another aspect of the present invention provides further one method of driving one or more than one light-emitting diodes with a pulsed current comprising the steps of: charging an inductance means via switching on a current flowing from a direct current (DC) voltage to the inductance means; discharging the inductance means via switching on a current flowing through a loop comprising said light-emitting diodes, the inductance means and the direct current (DC) voltage; controlling said charging and discharging to regulate the current of the inductance means for supplying the pulsed current to said light-emitting diodes.

Accordingly, since light generation of a white light-emitting diode is dependent on the current strength through the white light-emitting diode, to drive a white light-emitting diode with a pulsed current can remit illumination with higher peak illumination value to provide higher perceived brightness levels than to drive it with a constant current, the switching mode pulsed current supply disclosed by this application provide a better solution for driving light emitting diodes.

Another aspect of the present invention provides a switching mode pulsed current supply circuit for driving light-emitting diodes having longer lifetime than existing light-emitting diode drivers: since the present invention provides a switching mode pulsed current supply circuit that don't use aluminum electrolytic capacitors, therefore, the lifetime of the switching mode pulsed current supplies disclosed by present invention is much longer than existing solutions.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention.

### BRIEF DESCRIPTION OF THE DRAWINGS

The above and other features and advantages of the present general inventive concept will become more apparent by describing in detail exemplary embodiments thereof with reference to the attached drawings in which:

FIG. 1 is a block and circuit diagram illustrating an exemplary embodiment of a circuit according to a first method of the invention, wherein the inductance means is a flyback transformer.

FIG. 2 shows exemplary waveform diagrams illustrating the various waveforms at different points of circuits in FIG. 1, FIG. 3 and FIG. 4 in accordance with the present invention.

FIG. 3 is a block and circuit diagram illustrating a second exemplary embodiment of a circuit according to the first method of the invention, wherein the inductance means is a flyback transformer.

FIG. 4 is a block and circuit diagram illustrating a third exemplary embodiment of a circuit according to the first method of the invention, wherein the inductance means is an inductor.

FIG. 5 is a block and circuit diagram illustrating an exemplary embodiment of a circuit according to a second method of the invention, wherein the inductance means is a flyback transformer.

FIG. 6 shows exemplary waveform diagrams illustrating the various waveforms at different points of circuits in FIG. 5, FIG. 7 and FIG. 8 in accordance with the present invention.

FIG. 7 is a block and circuit diagram illustrating a second exemplary embodiment of a circuit according to the second method of the invention, wherein the inductance means is a flyback transformer.

FIG. 8 is a block and circuit diagram illustrating a third exemplary embodiment of a circuit according to the second method of the invention, wherein the inductance means is an inductor.

### DETAILED DESCRIPTION OF THE PREFERRED EMBODIMENTS

The detailed description set forth below in connection with the appended drawings is intended as a description of presently preferred embodiments of the invention and is not intended to represent the only forms in which the present invention may be constructed and or utilized.

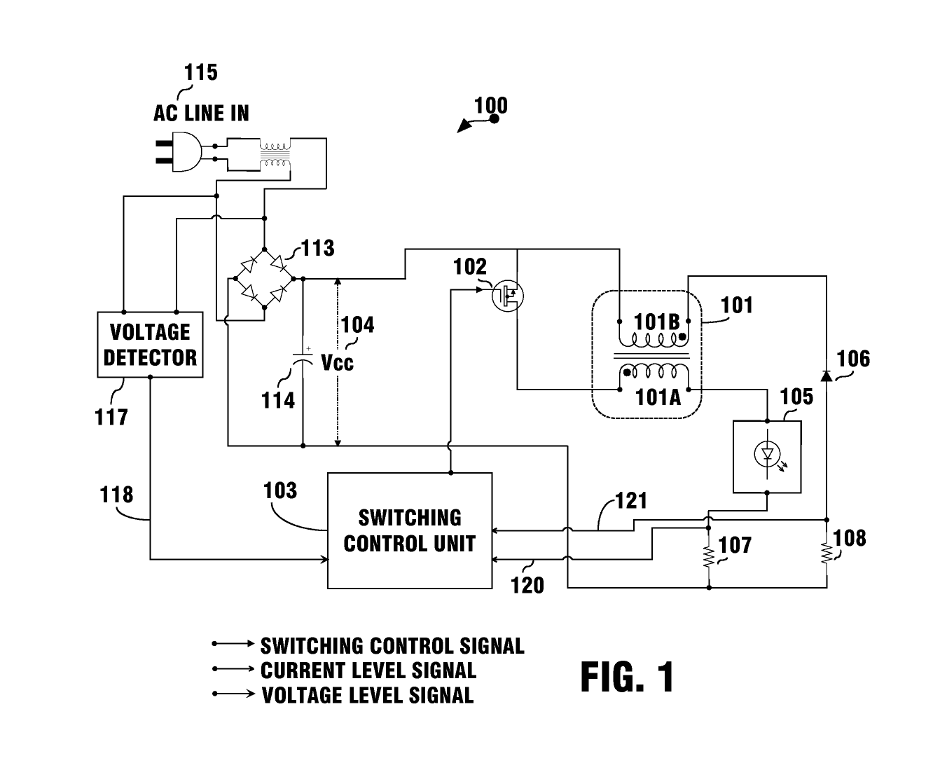

FIG. 1 is a block and circuit diagram illustrating an exemplary embodiment of a circuit 100 according to a first method of the invention, wherein the inductance means is a flyback transformer 101.

As illustrated in FIG. 1, the switching mode pulsed current supply circuit 100 for supplying a pulsed current to one or more than one light-emitting diodes 105 is disclosed, said circuit comprising: an inductance means which is the flyback transformer 101; a switching unit comprising a switch means 102 and a diode 106 for switching a current flowing through a loop comprising the direct current (DC) voltage 104, the switch means 102, the inductance means 101 and the light-emitting diodes 105; and for switching a current flowing from the diode 106 to the inductance means 101 to the direct current (DC) voltage 104; a switching control unit 103 coupled to the switching unit to control the switching of the switch means 102 to regulate the current of the inductance means 101 for supplying the pulsed current to said light-emitting diodes 105. Wherein the switch means 102 is a MOSFET

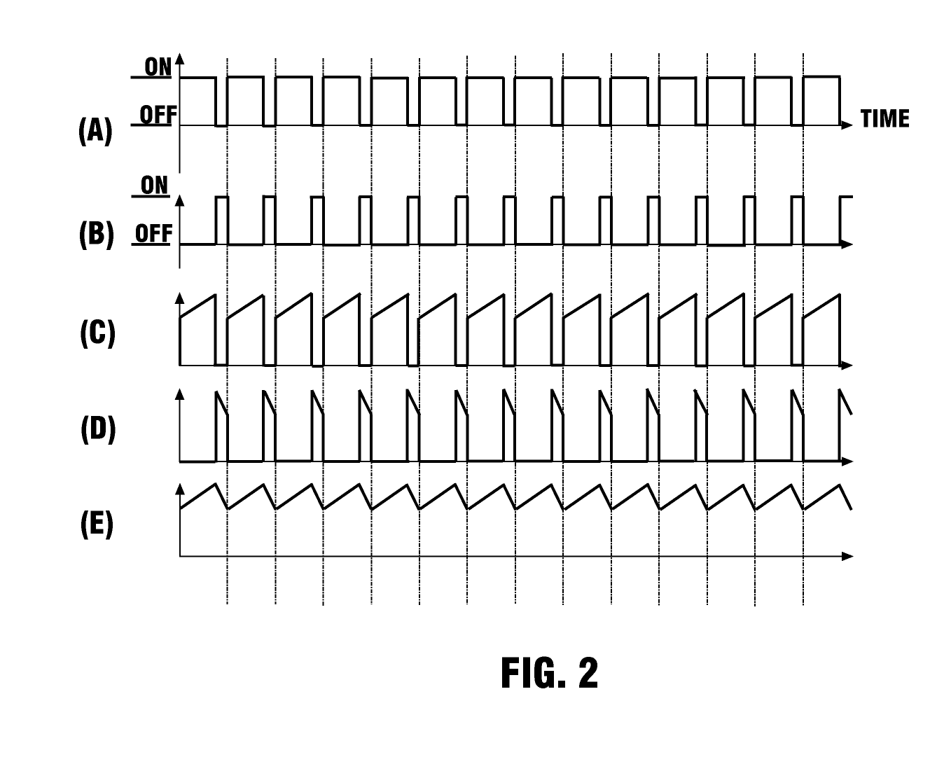

FIG. 2 shows exemplary waveform diagrams illustrating the various waveforms at different points of circuits in FIG. 1 in accordance with the present invention.

As illustrated in FIG. 1 and FIG. 2, a non-limiting exemplary waveform of switching control signals from the switching control unit 103 to the switch means 102 for controlling its switching is illustrated in FIG. 2(A). According to the switching control signals from the switching control unit 103 to the switch means 102 illustrated in FIG. 2(A); a non-limiting exemplary waveform of a current flowing through a loop comprising said light-emitting diodes 105, the inductance means 101 and the direct current (DC) voltage 104 is illustrated in FIG. 2(C); a non-limiting exemplary waveform of a current flowing from the diode 106 through the inductance means 101 to the direct current (DC) voltage 104 is illustrated in FIG. 2(D); a non-limiting exemplary waveform of a current flowing through the inductance means 101 is illustrated in FIG. 2(E).

As further illustrated in FIG. 1 and FIG. 2, the switch 102 switches on and off to charge and discharge the inductance means 101 for providing a pulsed current illustrated in FIG. 2(C) to said light-emitting diodes 105: when the switch 102 switches on, the inductance means 101 is charging energy from the direct current (DC) voltage 104 via the current illustrated in FIG. 2(C) flowing from the direct current (DC) voltage 104 through the winding 101A of the inductance means 101 to the light-emitting diodes 105; when the switch 102 switches off, then the diode 106 is forward biased via the inductance means 101, and the energy stored in the inductance means 101 is discharged back to the direct current (DC) voltage 104 through the current illustrated in FIG. 2(D) flowing from the diode 106 through the winding 101B of the inductance means 101 to the direct current (DC) voltage 104. Therefore, at steady state, the energy flow in and out of the inductance means 101 are determined according to the duty ratio between said charging and discharging. Thus, the switching of the switch 102 regulates the current of the inductance means 101 for supplying a pulsed current illustrated in FIG. 2(C) to said light-emitting diodes 105.

As further illustrated in FIG. 1 and FIG. 2, a method of driving one or more than one light-emitting diodes 105 with a pulsed current illustrated in FIG. 2(C) is disclosed that comprises the steps of: charging the inductance means 101 via switching on a current illustrated in FIG. 2(C) flowing through a loop comprising the direct current (DC) voltage 104, said light-emitting diodes 105, and the inductance means 101; discharging the inductance means 101 via switching on a current illustrated in FIG. 2(D) flowing from the inductance means 101 to the direct current (DC) voltage 104; controlling said charging and discharging via controlling the switching of the switch means 102 illustrated in FIG. 2(A) to regulate the current of the inductance means 101 illustrated in FIG. 2(E) for supplying the pulsed current illustrated in FIG. 2(C) to said light-emitting diodes 105.

As further illustrated in FIG. 1, the switching mode pulsed current supply circuit 100 further comprises a feedback current signal generator 108 to generate a feedback current signal 121 corresponding to the current of the inductance means 101, wherein the switching control unit 103 integrates the feedback current signal 121 to process a feedback control.

As further illustrated in FIG. 1, the switching mode pulsed current supply circuit 100 further comprises a feedback signal generator 107 to generate a feedback signal 120 corresponding to the current of said light-emitting diodes 105, wherein the switching control unit 103 integrates the feedback signal 120 to process a feedback control.

As further illustrated in FIG. 1, the switching mode pulsed current supply circuit 100 further comprises a rectifying unit 113 and smoothing unit 114 to rectify and smooth an alternating current (AC) voltage 115 for providing the direct current (DC) voltage 104.

As further illustrated in FIG. 1, the switching mode pulsed current supply circuit 100 further comprises an alternating current (AC) voltage signal generator 117 to generate an alternating current (AC) voltage signal 118 corresponding to the voltage of the alternating current (AC) voltage 115, wherein the switching control unit 103 integrates the alternating current (AC) voltage signal 118 to process a control for power factor correction. Accordingly, to regulate the pulsed current supplied to the light-emitting diodes 105 according to the AC voltage signal 118: when the AC voltage's magnitude is higher, then more energy corresponding to higher the pulsed current is switched to the light-emitting diodes 105; and when the AC voltage's magnitude is lower, then lesser energy corresponding to lower the pulsed current is switched to the light-emitting diodes 105 for providing power factor correction.

As further illustrated in FIG. 1, the switching mode pulsed current supply circuit 100 further comprises means for synchronizing pulses of the pulsed current illustrated in FIG. 2(C) supplied to said light-emitting diodes 105 to the phase of the alternating current (AC) voltage 115. Accordingly, the switching control unit 103 integrates the AC voltage signal 118 to synchronize pulses of the pulsed current illustrated in FIG. 2(C) supplied to the light-emitting diodes 105 to the phase of the AC voltage signal 118. The switching control unit 103 further comprises a phase lock loop circuit for the implementation of the synchronization between the pulsed current illustrated in FIG. 2(C) supplied to the light-emitting diodes 105 and the alternating current (AC) voltage 115. The advantage of this synchronization is: if there are more than one lighting apparatuses that each is driven by a circuit 100 in a lighting area, then all the lighting apparatuses are synchronized according to the alternating current (AC) voltage 115, the AC mains, coupled to all the lighting apparatuses, thus, all the pulsed illumination from the light sources are synchronized according to the AC mains to generate pulsed illumination at same time to provide better perceived brightness level.

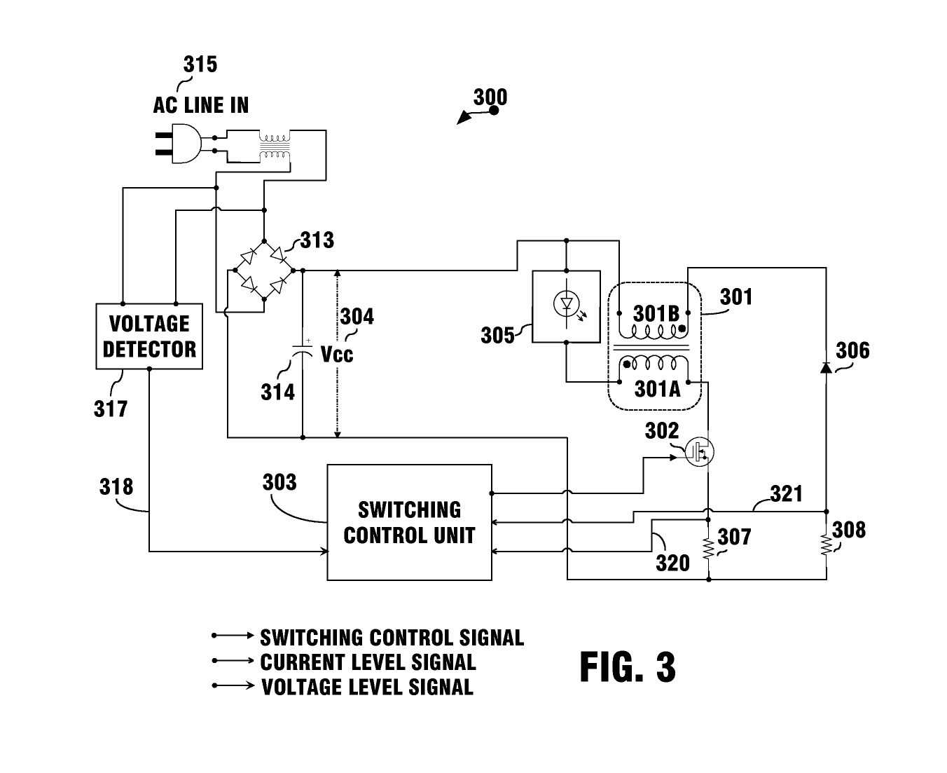

FIG. 3 is a block and circuit diagram illustrating a second exemplary embodiment of a circuit 300 according to the first method of the invention, wherein the inductance means is a flyback transformer 301.

As illustrated in FIG. 3, the switching mode pulsed current supply circuit 300 for supplying a pulsed current to one or more than one light-emitting diodes 305 is disclosed, said circuit comprising: an inductance means which is the flyback transformer 301; a switching unit comprising a switch means 302 and a diode 306 for switching a current flowing through a loop comprising the direct current (DC) voltage 304, the switch means 302, said light-emitting diodes 305, and the inductance means 301; and for switching a current flowing from the diode 306 to the inductance means 301 to the direct current (DC) voltage 304; a switching control unit 303 coupled to the switching unit to control the switching of the switch means 302 to regulate the current of the inductance means 301 for supplying the pulsed current to said light-emitting diodes 305. Wherein the switch means 302 is a N-type MOSFET

FIG. 2 shows exemplary waveform diagrams illustrating the various waveforms at different points of circuits in FIG. 3 in accordance with the present invention.

As illustrated in FIG. 3 and FIG. 2, a non-limiting exemplary waveform of switching control signals from the switching control unit 303 to the switch means 302 for controlling its switching is illustrated in FIG. 2(A). According to the switching control signals from the switching control unit 303 to the switch means 302 illustrated in FIG. 2(A); a non-limiting exemplary waveform of a current flowing through a loop comprising said light-emitting diodes 305, the inductance means 301 and the direct current (DC) voltage 304 is illustrated in FIG. 2(C); a non-limiting exemplary waveform of a current flowing from the diode 306 through the inductance means 301 to the direct current (DC) voltage 304 is illustrated in FIG. 2(D); a non-limiting exemplary waveform of a current flowing through the inductance means 301 is illustrated in FIG. 2(E).

As further illustrated in FIG. 3 and FIG. 2, the switch 302 switches on and off to charge and discharge the inductance means 301 for providing a pulsed current illustrated in FIG. 2(C) to said light-emitting diodes 305: when the switch 302 switches on, the inductance means 301 is charging energy from the direct current (DC) voltage 304 via the current illustrated in FIG. 2(C) flowing from the direct current (DC) voltage 304 through the light-emitting diodes 305 to the winding 301A of the inductance means 301; when the switch 302 switches off, then the diode 306 is forward biased via the inductance means 301, and the energy stored in the inductance means 301 is discharged back to the direct current (DC) voltage 304 through the current illustrated in FIG. 2(D) flowing from the diode 306 through the winding 301B of the inductance means 301 to the direct current (DC) voltage 304. Therefore, at steady state, the energy flow in and out of the inductance means 301 are determined according to the duty ratio between said charging and discharging. Thus, the switching of the switch 302 regulates the current of the inductance means 301 for supplying a pulsed current illustrated in FIG. 2(C) to said light-emitting diodes 305.

As further illustrated in FIG. 3 and FIG. 2, the method of driving one or more than one light-emitting diodes 305 with a pulsed current illustrated in FIG. 2(C) is disclosed that comprises the steps of: charging the inductance means 301 via switching on a current illustrated in FIG. 2(C) flowing through a loop comprising the direct current (DC) voltage 304, said light-emitting diodes 305, and the inductance means 301; discharging the inductance means 301 via switching on a current illustrated in FIG. 2(D) flowing from the inductance means 301 to the direct current (DC) voltage 304; controlling said charging and discharging via controlling the switching of the switch means 302 illustrated in FIG. 2(A) to regulate the current of the inductance means 301 illustrated in FIG. 2(E) for supplying the pulsed current illustrated in FIG. 2(C) to said light-emitting diodes 305.

As further illustrated in FIG. 3, the switching mode pulsed current supply circuit 300 further comprises a feedback current signal generator 308 to generate a feedback current signal 321 corresponding to the current of the inductance means 301, wherein the switching control unit 303 integrates the feedback current signal 321 to process a feedback control.

As further illustrated in FIG. 3, the switching mode pulsed current supply circuit 300 further comprises a feedback signal generator 307 to generate a feedback signal 320 corresponding to the current of said light-emitting diodes 305, wherein the switching control unit 303 integrates the feedback signal 320 to process a feedback control.

As further illustrated in FIG. 3, the switching mode pulsed current supply circuit 300 further comprises a rectifying unit 313 and smoothing unit 314 to rectify and smooth an alternating current (AC) voltage 315 for providing the direct current (DC) voltage 304.

As further illustrated in FIG. 3, the switching mode pulsed current supply circuit 300 further comprises an alternating current (AC) voltage signal generator 317 to generate an alternating current (AC) voltage signal 318 corresponding to the voltage of the alternating current (AC) voltage 315, wherein the switching control unit 303 integrates the alternating current (AC) voltage signal 318 to process a control for power factor correction. Accordingly, to regulate the pulsed current supplied to the light-emitting diodes 305 according to the AC voltage signal 318: when the AC voltage's magnitude is higher, then more energy corresponding to higher the pulsed current is switched to the light-emitting diodes 305; and when the AC voltage's magnitude is lower, then lesser energy corresponding to lower the pulsed current is switched to the light-emitting diodes 305 for providing power factor correction.

As further illustrated in FIG. 3, the switching mode pulsed current supply circuit 300 further comprises means for synchronizing pulses of the pulsed current illustrated in FIG. 2(C) supplied to said light-emitting diodes 305 to the phase of the alternating current (AC) voltage 315. Accordingly, the switching control unit 303 integrates the AC voltage signal 318 to synchronize pulses of the pulsed current illustrated in FIG. 2(C) supplied to the light-emitting diodes 305 to the phase of the AC voltage signal 318. The switching control unit 303 further comprises a phase lock loop circuit for the implementation of the synchronization between the pulsed current illustrated in FIG. 2(C) supplied to the light-emitting diodes 305 and the alternating current (AC) voltage 315. The advantage of this synchronization is: if there are more than one lighting apparatuses that each is driven by a circuit 300 in a lighting area, then all the lighting apparatuses are synchronized according to the alternating current (AC) voltage 315, the AC mains, coupled to all the lighting apparatuses, thus, all the pulsed illumination from the light sources are synchronized according to the AC mains to generate pulsed illumination at same time to provide better perceived brightness level.

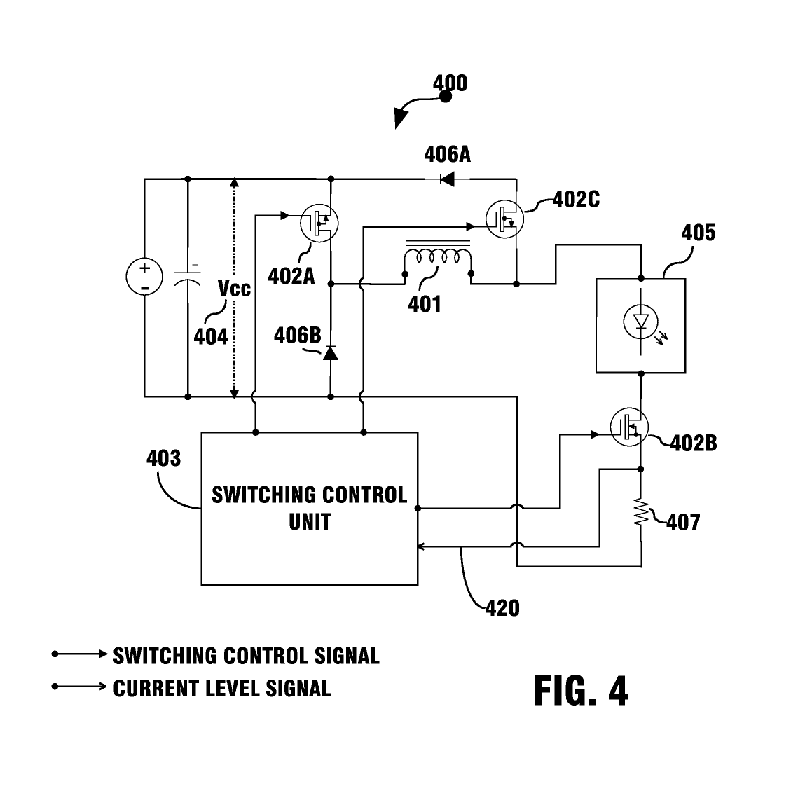

FIG. 4 is a block and circuit diagram illustrating a third exemplary embodiment of a circuit 400 according to the first method of the invention, wherein the inductance means is an inductor 401.

As illustrated in FIG. 4, the switching mode pulsed current supply circuit 400 for supplying a pulsed current to one or more than one light-emitting diodes 405 is disclosed, said circuit comprising: an inductance means which is the inductor 401; a switching unit comprising switches 402A, 402B, 402C and diodes 406A, 406B for switching a current flowing through a loop comprising the direct current (DC) voltage 404, the light-emitting diodes 405, and the inductor 401; and for switching a current flowing from the diode 406B to the inductance means 401 to the switch 402C to the diode 406A to the direct current (DC) voltage 404; a switching control unit 403 coupled to the switching unit to control the switching of the switches 402A, 402B, 402C to regulate the current of the inductance means 401 for supplying the pulsed current to said light-emitting diodes 405.

FIG. 2 shows exemplary waveform diagrams illustrating the various waveforms at different points of circuits in FIG. 4 in accordance with the present invention.

As illustrated in FIG. 4 and FIG. 2, a non-limiting exemplary waveform of switching control signals from the switching control unit 403 to the switches 402A, 402B for controlling their switching is illustrated in FIG. 2(A), and a non-limiting exemplary waveform of switching control signals from the switching control unit 403 to the switch 402C for controlling its switching is illustrated in FIG. 2(B). According to the switching control signals from the switching control unit 403 to the switches 402A, 402B, and 402C illustrated in FIG. 2(A) and FIG. 2(B); a non-limiting exemplary waveform of a current flowing through a loop comprising said light-emitting diodes 405, the inductance means 401 and the direct current (DC) voltage 404 is illustrated in FIG. 2(C); a non-limiting exemplary waveform of a current flowing from the diode 406B through the inductance means 401 to the switch 402C to the diode 406A to the direct current (DC) voltage 404 is illustrated in FIG. 2(D); a non-limiting exemplary waveform of a current flowing through the inductance means 401 is illustrated in FIG. 2(E).

As further illustrated in FIG. 4 and FIG. 2, the switches 402A, 402B and 402C switch on and off to charge and discharge the inductance means 401 for providing a pulsed current illustrated in FIG. 2(C) to said light-emitting diodes 405: when the switch 402A, 402B switch on and the switch 402C switches off, the inductance means 401 is charging energy from the direct current (DC) voltage 404 via the current illustrated in FIG. 2(C) flowing from the direct current (DC) voltage 404 through the inductance means 401 to the light-emitting diodes 405; when the switch 402A, 402B switch off and the switch 402C switches on, then the diodes 406A, 406B are forward biased via the inductance means 401, and the energy stored in the inductance means 401 is discharged back to the direct current (DC) voltage 404 through the current illustrated in FIG. 2(D) flowing from the diode 406B through the inductance means 401 to the direct current (DC) voltage 404. Therefore, at steady state, the energy flow in and out of the inductance means 401 are determined according to the duty ratio between said charging and discharging. Thus, the switching of the switches 402A, 402B and 402C regulates the current of the inductance means 401 for supplying a pulsed current illustrated in FIG. 2(C) to said light-emitting diodes 405.

As further illustrated in FIG. 4 and FIG. 2, the method of driving one or more than one light-emitting diodes 405 with a pulsed current illustrated in FIG. 2(C) is disclosed that comprises the steps of: charging the inductance means 401 via switching on a current illustrated in FIG. 2(C) flowing through a loop comprising the direct current (DC) voltage 404, said light-emitting diodes 405, and the inductance means 401; discharging the inductance means 401 via switching on a current illustrated in FIG. 2(D) flowing from the inductance means 401 to the direct current (DC) voltage 404; controlling said charging and discharging via controlling the switching of the switch means 402A, 402B and 402C illustrated in FIG. 2(A) and FIG. 2(B) respectively to regulate the current of the inductance means 401 illustrated in FIG. 2(E) for supplying the pulsed current illustrated in FIG. 2(C) to said light-emitting diodes 405.

As further illustrated in FIG. 4, the switching mode pulsed current supply circuit 400 further comprises a feedback signal generator 407 to generate a feedback signal 420 corresponding to the current of said light-emitting diodes 405, wherein the switching control unit 403 integrates the feedback signal 420 to process a feedback control.

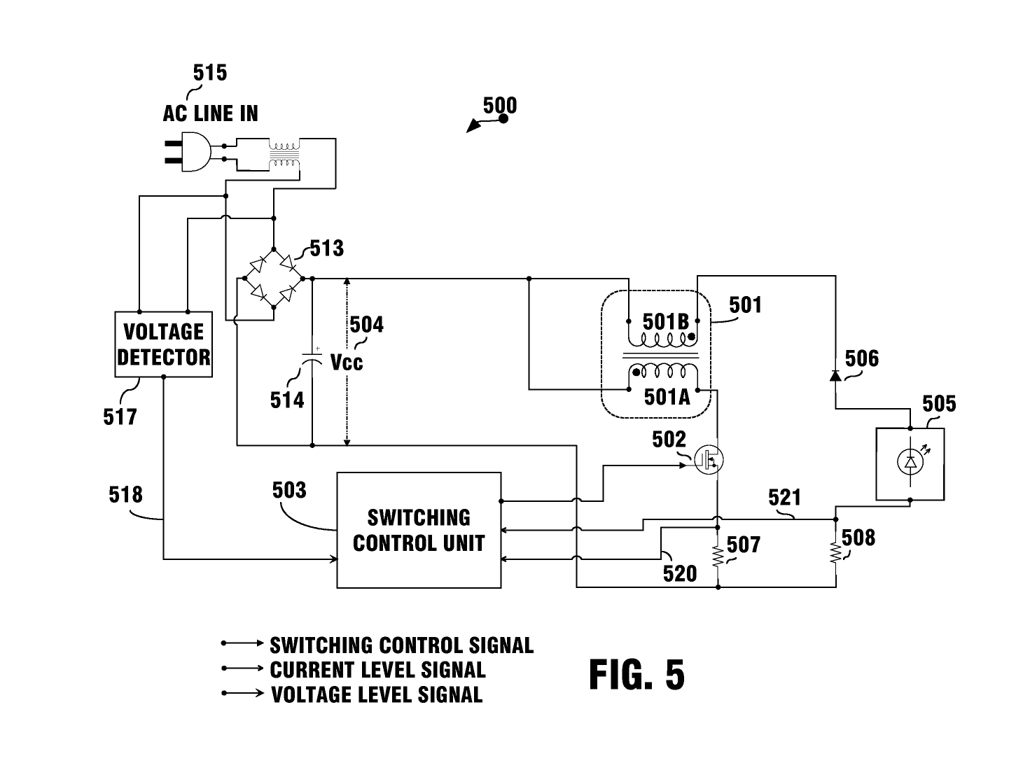

FIG. 5 is a block and circuit diagram illustrating an exemplary embodiment of a circuit 500 according to a second method of the invention, wherein the inductance means is a flyback transformer 501.

As illustrated in FIG. 5, the switching mode pulsed current supply circuit 500 for supplying a pulsed current to one or more than one light-emitting diodes 505 is disclosed, said circuit comprising: an inductance means which is the flyback transformer 501; a switching unit comprising a switch means 502 and a diode 506 for switching a current flowing from a direct current (DC) voltage 504 to the inductance means 501, and for switching a current flowing through a loop comprising said light-emitting diodes 505, the inductance means 501 and the direct current (DC) voltage 504; a switching control unit 503 coupled to the switching unit to control the switching of the switch means 502 to regulate the current of the inductance means 501 for supplying the pulsed current to said light-emitting diodes 505. Wherein the switch means 502 is a MOSFET.

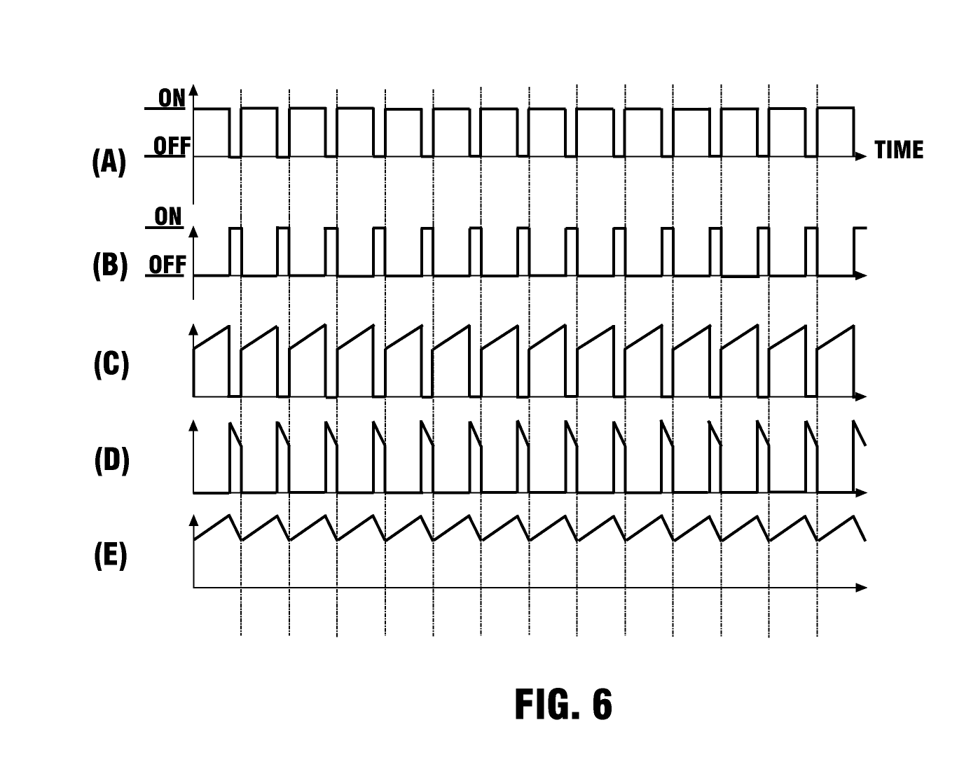

FIG. 6 shows exemplary waveform diagrams illustrating the various waveforms at different points of circuits in FIG. 5 in accordance with the present invention.

As illustrated in FIG. 5 and FIG. 6, a non-limiting exemplary waveform of switching control signals from the switching control unit 503 to the switch means 502 for controlling its switching is illustrated in FIG. 6(A). According to the switching control signals from the switching control unit 503 to the switch means 502 illustrated in FIG. 6(A), a non-limiting exemplary waveform of a current flowing from the direct current (DC) voltage 504 to the winding 501A of the inductance means 501 is illustrated in FIG. 6(C); a non-limiting exemplary waveform of a current flowing through a loop from the light-emitting diodes 505 to the winding 501B of the inductance means 501 to the direct current (DC) voltage 504 is illustrated in FIG. 6(D); a non-limiting exemplary waveform of a current flowing through the inductance means 501 is illustrated in FIG. 6(E).

As further illustrated in FIG. 5 and FIG. 6, the switch 502 switches on and off to charge and discharge the inductance means 501 for providing a pulsed current illustrated in FIG. 6(D) to said light-emitting diodes 505: when the switch 502 switches on, the inductance means 501 is charging energy from the direct current (DC) voltage 504 via the current illustrated in FIG. 6(C) flowing from the direct current (DC) voltage 504 to the winding 501A of the inductance means 501; when the switch 502 switches off, then the diode 506 is forward biased via the inductance means 501, and the energy stored in the inductance means 501 is discharged to the light-emitting diodes 505 and to the direct current (DC) voltage 504 through the current illustrated in FIG. 6(D) flowing from said light-emitting diodes 505 to the diode 506 to the winding 501B of the inductance means 501 to the direct current (DC) voltage 504. Therefore, at steady state, the energy flow in and out of the inductance means 501 are determined according to the duty ratio between said charging and discharging. Thus, the switching of the switch 502 regulates the current of the inductance means 501 illustrated in FIG. 6(E) for supplying a pulsed current illustrated in FIG. 6(D) to said light-emitting diodes 505.

As further illustrated in FIG. 5 and FIG. 6, a method of driving one or more than one light-emitting diodes 505 with a pulsed current illustrated in FIG. 6(D) is disclosed that comprises the steps of: charging the inductance means 501 via switching on a current flowing from the direct current (DC) voltage 504 to the inductance means 501; discharging the inductance means 501 via switching on a current flowing through a loop from said light-emitting diodes 505, to the inductance means 501 and to the direct current (DC) voltage 504; controlling said charging and discharging via controlling the switching of the switch means 502 illustrated in FIG. 6(A) to regulate the current of the inductance means 501 illustrated in FIG. 6(E) for supplying the pulsed current illustrated in FIG. 6(D) to said light-emitting diodes 505.

As further illustrated in FIG. 5, the switching mode pulsed current supply circuit 500 further comprises a feedback current signal generator 507 to generate a feedback current signal 520 corresponding to the current of the inductance means 501, wherein the switching control unit 503 integrates the feedback current signal 520 to process a feedback control.

As further illustrated in FIG. 5, the switching mode pulsed current supply circuit 500 further comprises a feedback signal generator 507 to generate a feedback signal 521 corresponding to the current of said light-emitting diodes 505, wherein the switching control unit 503 integrates the feedback signal 521 to process a feedback control.

As further illustrated in FIG. 5, the switching mode pulsed current supply circuit 500 further comprises a rectifying unit 513 and smoothing unit 514 to rectify and smooth an alternating current (AC) voltage 515 for providing the direct current (DC) voltage 504.

As further illustrated in FIG. 5, the switching mode pulsed current supply circuit 500 further comprises an alternating current (AC) voltage signal generator 517 to generate an alternating current (AC) voltage signal 518 corresponding to the voltage of the alternating current (AC) voltage 515, wherein the switching control unit 503 integrates the alternating current (AC) voltage signal 518 to process a control for power factor correction. Accordingly, to regulate the pulsed current supplied to the light-emitting diodes 505 according to the AC voltage signal 518: when the AC voltage's magnitude is higher, then more energy corresponding to higher the pulsed current is switched to the light-emitting diodes 505; and when the AC voltage's magnitude is lower, then lesser energy corresponding to lower the pulsed current is switched to the light-emitting diodes 505 for providing power factor correction.

As further illustrated in FIG. 5, the switching mode pulsed current supply circuit 500 further comprises means for synchronizing pulses of the pulsed current illustrated in FIG. 6(D) supplied to said light-emitting diodes 505 to the phase of the alternating current (AC) voltage 515. Accordingly, the switching control unit 503 integrates the AC voltage signal 518 to synchronize pulses of the pulsed current illustrated in FIG. 6(D) supplied to the light-emitting diodes 505 to the phase of the AC voltage signal 518. The switching control unit 503 further comprises a phase lock loop circuit for the implementation of the synchronization between the pulsed current illustrated in FIG. 6(D) supplied to the light-emitting diodes 505 and the alternating current (AC) voltage 515. The advantage of this synchronization is: if there are more than one lighting apparatuses that each is driven by a circuit 500 in a lighting area, then all the lighting apparatuses are synchronized according to the alternating current (AC) voltage 515, the AC mains, coupled to all the lighting apparatuses, thus, all the pulsed illumination from the light sources are synchronized according to the AC mains to generate pulsed illumination at same time to provide better perceived brightness level.

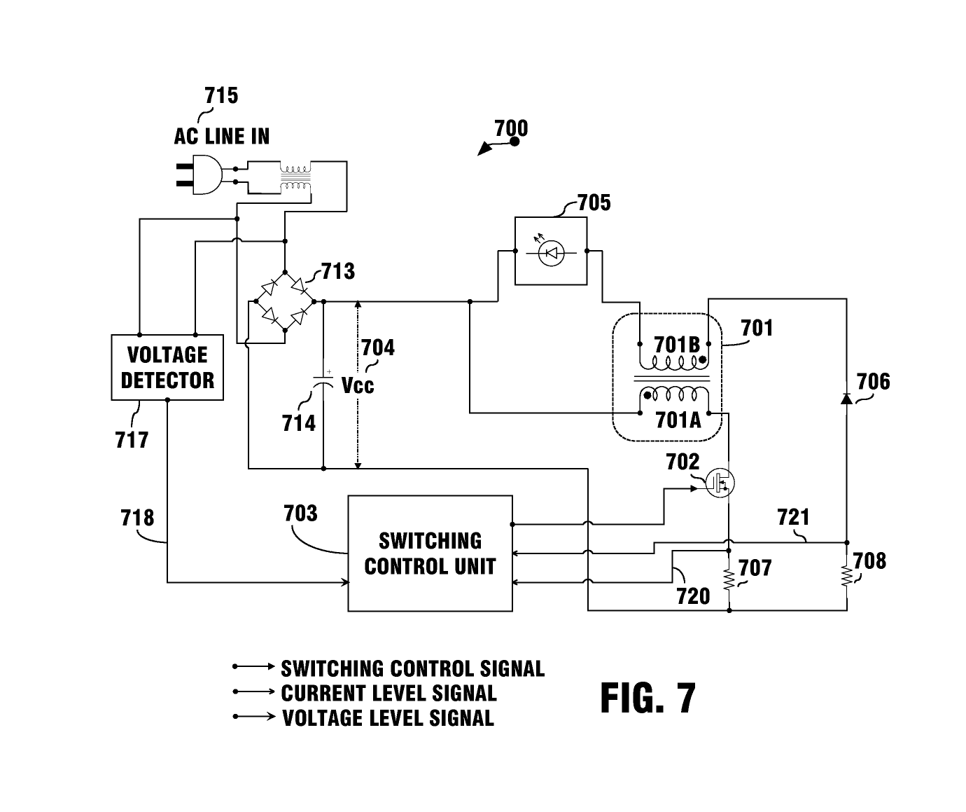

FIG. 7 is a block and circuit diagram illustrating a second exemplary embodiment of a circuit 700 according to the second method of the invention, wherein the inductance means is a flyback transformer 701.

As illustrated in FIG. 7, the switching mode pulsed current supply circuit 700 for supplying a pulsed current to one or more than one light-emitting diodes 705 is disclosed, said circuit comprising: an inductance means which is the flyback transformer 701; a switching unit comprising a switch means 702 and a diode 706 for switching a current flowing from a direct current (DC) voltage 704 to the inductance means 701, and for switching a current flowing through a loop comprising said light-emitting diodes 705, the inductance means 701 and the direct current (DC) voltage 704; a switching control unit 703 coupled to the switching unit to control the switching of the switch means 702 to regulate the current of the inductance means 701 for supplying the pulsed current to said light-emitting diodes 705. Wherein the switch means 702 is a MOSFET.

FIG. 6 shows exemplary waveform diagrams illustrating the various waveforms at different points of circuits in FIG. 7 in accordance with the present invention.

As illustrated in FIG. 7 and FIG. 6, a non-limiting exemplary waveform of switching control signals from the switching control unit 703 to the switch means 702 for controlling its switching is illustrated in FIG. 6(A). According to the switching control signals from the switching control unit 703 to the switch means 702 illustrated in FIG. 6(A), a non-limiting exemplary waveform of a current flowing from the direct current (DC) voltage 704 to the winding 701A of the inductance means 701 is illustrated in FIG. 6(C); a non-limiting exemplary waveform of a current flowing through a loop from the winding 701B of the inductance means 701 to the light-emitting diodes 705 to the direct current (DC) voltage 704 is illustrated in FIG. 6(D); a non-limiting exemplary waveform of a current flowing through the inductance means 701 is illustrated in FIG. 6(E).

As further illustrated in FIG. 7 and FIG. 6, the switch 702 switches on and off to charge and discharge the inductance means 701 for providing a pulsed current illustrated in FIG. 6(D) to said light-emitting diodes 705: when the switch 702 switches on, the inductance means 701 is charging energy from the direct current (DC) voltage 704 via the current illustrated in FIG. 6(C) flowing from the direct current (DC) voltage 704 to the winding 701A of the inductance means 701; when the switch 702 switches off, then the diode 706 is forward biased via the inductance means 701, and the energy stored in the inductance means 701 is discharged to the light-emitting diodes 705 and to the direct current (DC) voltage 704 through the current illustrated in FIG. 6(D) flowing from the diode 706 to the winding 701B of the inductance means 701 to said light-emitting diodes 705 to the direct current (DC) voltage 704. Therefore, at steady state, the energy flow in and out of the inductance means 701 are determined according to the duty ratio between said charging and discharging. Thus, the switching of the switch 702 regulates the current of the inductance means 701 illustrated in FIG. 6(E) for supplying a pulsed current illustrated in FIG. 6(D) to said light-emitting diodes 705.

As further illustrated in FIG. 7 and FIG. 6, the method of driving one or more than one light-emitting diodes 705 with a pulsed current illustrated in FIG. 6(D) is disclosed and comprises the steps of: charging the inductance means 701 via switching on a current flowing from the direct current (DC) voltage 704 to the inductance means 701; discharging the inductance means 701 via switching on a current flowing through a loop from said light-emitting diodes 705, the inductance means 701 and the direct current (DC) voltage 704; controlling said charging and discharging via controlling the switching of the switch means 702 illustrated in FIG. 6(A) to regulate the current of the inductance means 701 illustrated in FIG. 6(E) for supplying the pulsed current illustrated in FIG. 6(D) to said light-emitting diodes 705.

As further illustrated in FIG. 7, the switching mode pulsed current supply circuit 700 further comprises a feedback current signal generator 707 to generate a feedback current signal 720 corresponding to the current of the inductance means 701, wherein the switching control unit 703 integrates the feedback current signal 720 to process a feedback control.

As further illustrated in FIG. 7, the switching mode pulsed current supply circuit 700 further comprises a feedback signal generator 708 to generate a feedback signal 721 corresponding to the current of said light-emitting diodes 705, wherein the switching control unit 703 integrates the feedback signal 721 to process a feedback control.

As further illustrated in FIG. 7, the switching mode pulsed current supply circuit 700 further comprises a rectifying unit 713 and smoothing unit 714 to rectify and smooth an alternating current (AC) voltage 715 for providing the direct current (DC) voltage 704.

As further illustrated in FIG. 7, the switching mode pulsed current supply circuit 700 further comprises an alternating current (AC) voltage signal generator 717 to generate an alternating current (AC) voltage signal 718 corresponding to the voltage of the alternating current (AC) voltage 715, wherein the switching control unit 703 integrates the alternating current (AC) voltage signal 718 to process a control for power factor correction. Accordingly, to regulate the pulsed current supplied to the light-emitting diodes 705 according to the AC voltage signal 718: when the AC voltage's magnitude is higher, then more energy corresponding to higher the pulsed current is switched to the light-emitting diodes 705; and when the AC voltage's magnitude is lower, then lesser energy corresponding to lower the pulsed current is switched to the light-emitting diodes 705 for providing power factor correction.

As further illustrated in FIG. 7, the switching mode pulsed current supply circuit 700 further comprises means for synchronizing pulses of the pulsed current illustrated in FIG. 6(D) supplied to said light-emitting diodes 705 to the phase of the alternating current (AC) voltage 715. Accordingly, the switching control unit 703 integrates the AC voltage signal 718 to synchronize pulses of the pulsed current illustrated in FIG. 6(D) supplied to the light-emitting diodes 705 to the phase of the AC voltage signal 718. The switching control unit 703 further comprises a phase lock loop circuit for the implementation of the synchronization between the pulsed current illustrated in FIG. 6(D) supplied to the light-emitting diodes 705 and the alternating current (AC) voltage 715. The advantage of this synchronization is: if there are more than one lighting apparatuses that each is driven by a circuit 700 in a lighting area, then all the lighting apparatuses are synchronized according to the alternating current (AC) voltage 715, the AC mains, coupled to all the lighting apparatuses, thus, all the pulsed illumination from the light sources are synchronized according to the AC mains to generate pulsed illumination at same time to provide better perceived brightness level.

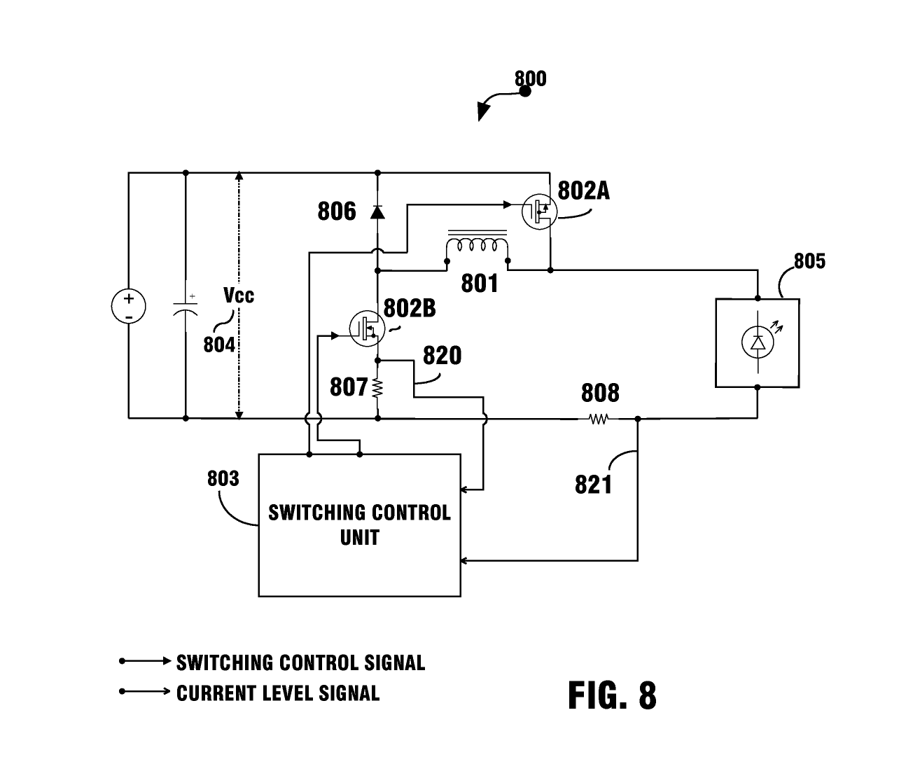

FIG. 8 is a block and circuit diagram illustrating a third exemplary embodiment of a circuit 800 according to the second method of the invention, wherein the inductance means is an inductor 801.

As illustrated in FIG. 8, the switching mode pulsed current supply circuit 800 for supplying a pulsed current to one or more than one light-emitting diodes 805 is disclosed, said circuit comprising: an inductance means which is the inductor 801; a switching unit comprising switch means 802A, 802B and a diode 806 for switching a current flowing from a direct current (DC) voltage 804 to the inductance means 801, and for switching a current flowing through a loop comprising said light-emitting diodes 805, the inductance means 801 and the direct current (DC) voltage 804; a switching control unit 803 coupled to the switching unit to control the switching of the switch means 802A, 802B to regulate the current of the inductance means 801 for supplying the pulsed current to said light-emitting diodes 805. Wherein the switch means 802A, 802B are MOSFETs.

FIG. 6 shows exemplary waveform diagrams illustrating the various waveforms at different points of circuits in FIG. 8 in accordance with the present invention.

As illustrated in FIG. 8 and FIG. 6, a non-limiting exemplary waveform of switching control signals from the switching control unit 803 to the switch means 802A and 802B for controlling their switching is illustrated in FIG. 6(A). According to the switching control signals from the switching control unit 803 to the switch means 802A, 802B illustrated in FIG. 6(A), a non-limiting exemplary waveform of a current flowing from the direct current (DC) voltage 804 through the switch 802A to the inductance means 801 to the switch 802B is illustrated in FIG. 6(C); a non-limiting exemplary waveform of a current flowing through a loop from the light-emitting diodes 805 to the inductance means 801 to the direct current (DC) voltage 804 is illustrated in FIG. 6(D); a non-limiting exemplary waveform of a current flowing through the inductance means 801 is illustrated in FIG. 6(E).

As further illustrated in FIG. 8 and FIG. 6, the switches 802A, 802B switch on and off to charge and discharge the inductance means 801 for providing a pulsed current illustrated in FIG. 6(D) to said light-emitting diodes 805: when the switches 802A and 802B switch on, the inductance means 801 is charging energy from the direct current (DC) voltage 804 via the current illustrated in FIG. 6(C) flowing from the direct current (DC) voltage 804 to the switch 802A to the inductance means 801; when the switches 802A and 802B switch off, then the diode 806 is forward biased via the inductance means 801, and the energy stored in the inductance means 801 is discharged to the light-emitting diodes 805 and to the direct current (DC) voltage 804 through the current illustrated in FIG. 6(D) flowing from said light-emitting diodes 805 to the inductance means 801 to the diode 806 to the direct current (DC) voltage 804. Therefore, at steady state, the energy flow in and out of the inductance means 801 are determined according to the duty ratio between said charging and discharging. Thus, the switching of the switches 802A, 802B regulates the current of the inductance means 801 illustrated in FIG. 6(E) for supplying a pulsed current illustrated in FIG. 6(D) to said light-emitting diodes 805.

As further illustrated in FIG. 8 and FIG. 6, the method of driving one or more than one light-emitting diodes 805 with a pulsed current illustrated in FIG. 6(D) is disclosed that comprises the steps of: charging the inductance means 801 via switching on a current flowing from the direct current (DC) voltage 804 to the inductance means 801; discharging the inductance means 801 via switching on a current flowing through a loop from said light-emitting diodes 805, the inductance means 801 and the direct current (DC) voltage 804; controlling said charging and discharging via controlling the switching of the switch means 802A, 802B illustrated in FIG. 6(A) to regulate the current of the inductance means 801 illustrated in FIG. 6(E) for supplying the pulsed current illustrated in FIG. 6(D) to said light-emitting diodes 805.

As further illustrated in FIG. 8, the switching mode pulsed current supply circuit 800 further comprises a feedback current signal generator 807 to generate a feedback current signal 820 corresponding to the current of the inductance means 801, wherein the switching control unit 803 integrates the feedback current signal 820 to process a feedback control.

As further illustrated in FIG. 8, the switching mode pulsed current supply circuit 800 further comprises a feedback signal generator 808 to generate a feedback signal 821 corresponding to the current of said light-emitting diodes 805, wherein the switching control unit 803 integrates the feedback signal 821 to process a feedback control.

Accordingly, since light generation of a white light-emitting diode is dependent on the current strength through the white light-emitting diode, to drive a white light-emitting diode with a pulsed current can remit illumination with higher peak illumination value to provide higher perceived brightness levels than to drive it with a constant current, the switching mode pulsed current supplies 100, 300, 400, 500, 700 and 800 provide a better solution for driving light emitting diodes.

Another aspect of the present invention provides switching mode pulsed current supplies 100, 300, 400, 500, 700 and 800 for driving light-emitting diodes having longer lifetime than existing light-emitting diode drivers: since the present invention provides a switching mode pulsed current supply that don't use aluminum electrolytic capacitors, therefore, the lifetime of the switching mode pulsed current supplies 100, 300, 400, 500, 700 and 800 disclosed by present invention is much longer than existing solutions.

It is to be understood that the above described embodiments are merely illustrative of the principles of the invention and that other arrangements may be devised by those skilled in the art without departing from the spirit and scope of the invention.

1. A method of driving one or more than one light-emitting diodes with a pulsed current comprising:
switching the pulsed current flowing through a loop comprising a direct current (DC) voltage, said light-emitting diodes, and an inductance means for charging the inductance means and supplying the pulsed current to the light-emitting diodes;
switching a current from the inductance means to the direct current (DC) voltage for discharging the inductance means;
wherein switching the pulsed current and switching the current are controlled to regulate the pulsed current supplied to said light-emitting diodes.

2. The method of claim 1 further comprising:
getting a feedback current signal by detecting the current of the inductance means and integrating the feedback current signal to process a feedback control.

3. The method of claim 1 further comprising:
getting a feedback signal by detecting the current of said light-emitting diodes and integrating the feedback signal to process a feedback control.

4. The method of claim 1 further comprising:
rectifying and smoothing an alternating current (AC) voltage for obtaining the direct current (DC) voltage.

5. The method of claim 4 further comprising:
getting an alternating current (AC) voltage signal by detecting the voltage of the alternating current (AC) voltage and integrating the alternating current (AC) voltage signal to process a control for power factor correction.

6. The method of claim 4 further comprising:
synchronizing the pulses of the pulsed current supplied to the light-emitting diodes to the phase of the alternating current (AC) voltage.

7. The method according to claim 1, wherein the inductance means comprises an inductor or a flyback transformer.

8. A method of driving one or more than one light-emitting diodes with a pulsed current comprising the steps of:
switching a current from a direct current (DC) voltage to an inductance means for charging the inductance means;
switching the pulsed current flowing through a loop comprising said light-emitting diodes, the inductance means and the direct current (DC) voltage for discharging the inductance means and supplying the pulsed current to the light-emitting diodes;
wherein switching the current and switching the pulsed current are controlled to regulate the pulsed current supplied to said light-emitting diodes.

9. The method of claim 8 further comprising:
getting a feedback current signal by detecting the current of the inductance means and integrating the feedback current signal to process a feedback control.

10. The method of claim 8 further comprising:
getting a feedback signal by detecting the current of said light-emitting diodes and integrating the feedback signal to process a feedback control.

11. The method of claim 8 further comprising:
rectifying and smoothing an alternating current (AC) voltage for obtaining the direct current (DC) voltage.

12. The method of claim 11 further comprising:
getting an alternating current (AC) voltage signal by detecting the voltage of the alternating current (AC) voltage and integrating the alternating current (AC) voltage signal to process a control for power factor correction.

13. The method of claim 11 further comprising:
synchronizing the pulses of the pulsed current supplied to the light-emitting diodes to the phase of the alternating current (AC) voltage.

14. The method according to claim 8, wherein the inductance means comprises an inductor or a flyback transformer.

15. A circuit for supplying a pulsed current to one or more than one light-emitting diodes, said circuit comprising:
an inductance means;
a switching unit comprising one or more switches for switching the pulsed current flowing through a loop comprising a direct current (DC) voltage, the inductance means and said light-emitting diodes, and for switching a current from the inductance means to the direct current (DC) voltage or switching a current from the direct current (DC) voltage to the inductance means;
a switching control unit coupled to the switching unit to control the switches of the switching unit to regulate the pulsed current supplied to said light-emitting diodes.

16. The circuit according to claim 15, further comprising:
a feedback current signal generator to generate a feedback current signal corresponding to the current of the inductance means,
wherein the switching control unit integrates the feedback current signal to process a feedback control.

17. The circuit according to claim 15, further comprising:
a feedback signal generator to generate a feedback signal corresponding to the current of said light-emitting diodes,
wherein the switching control unit integrates the feedback signal to process a feedback control.

18. The circuit according to claim 15, further comprising:
a rectifying and smoothing unit to rectify and smooth an alternating current (AC) voltage for providing the direct current (DC) voltage.

19. The circuit according to claim 18, further comprising:
an alternating current (AC) voltage signal generator to generate an alternating current (AC) voltage signal corresponding to the voltage of the alternating current (AC) voltage,
wherein the switching control unit integrates the alternating current (AC) voltage signal to process a control for power factor correction.

20. The circuit according to claim 18, further comprising:
an alternating current (AC) voltage signal generator to generate an alternating current (AC) voltage signal corresponding to the voltage of the alternating current (AC) voltage, wherein the switching control unit integrates the alternating current (AC) voltage signal to synchronize the pulsed current supplied to said light-emitting diodes to the phase of the alternating current (AC) voltage.
